(19) United States
(12) Patent Application Publication
(10) Pub. No.: US 2006/0101519 A1
(43) Pub. Date: May 11, 2006

(54) Method to provide customized vulnerability information to a plurality of organizations

(76) Inventors: Kevin W. Lasswell, Highlands Ranch, CO (US); Troy T. Schumaker, Pine, CO (US); Demetrios Lazarikos, Denver, CO (US)

Correspondence Address: Mark A. Thomas, P.C., 10138 South Cottoncreek Drive, Highlands Ranch, CO, 80130-3848, US

(21) Appl. No.: 11/268,991

(22) Filed: Nov. 7, 2005

Related U.S. Application Data
(60) Provisional application No. 60/625,682, filed on Nov. 5, 2004.
(60) Provisional application No. 60/625,678, filed on Nov. 5, 2004.
(60) Provisional application No. 60/625,679, filed on Nov. 5, 2004.

(51) Int. Cl. G06F 11/00

(52) U.S. Cl. 726/25

(57) ABSTRACT

The present invention provides a means of providing computer security vulnerability information to a plurality of organizations such that the vulnerability information provided to each organization is customized to its network environment. Each organization has an Enterprise Server. An asset management module in each organization's Enterprise Servers sends device configuration information to a system at a Co-Location Facility. The Co-Location Facility system aggregates this data. Information concerning vulnerabilities is also gathered from computer equipment vendors on an ongoing basis. This vulnerability information is compared to the aggregated data from the organizations' Enterprise Servers, and only the vulnerability information relevant to each organization is delivered back to that organization. The delivered information is then used to customize the vulnerability assessment and management activities, including scanning, for each organization such that their activities are limited to vulnerabilities that are directly related to their environment.

### CROSS REFERENCES TO RELATED APPLICATIONS

This patent application claims the benefit of provisional U.S. Patent Application Ser. No. 60/625,682, filed Nov. 5^{th}, 2004, provisional U.S. Patent Application Ser. No. 60/625,678, filed Nov. 5^{th}, 2004 and provisional U.S. Patent Application Ser. No. 60/625,679, filed Nov. 5^{th}, 2004, all of which are hereby incorporated by reference in their entireties.

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The invention relates generally to computer security and the detection, management, and resolution of computer vulnerabilities. In particular, the invention relates to the dissemination of computer security vulnerability information to a plurality of organizations from a single source.

2. Description of the Related Art

Computer networks have created an interconnected world wherein computers can be accessed from anywhere through a public network connection. This interconnectedness has, along with its advantages, created an environment where computers may be attacked or accessed by unauthorized entities. Interconnected computers are vulnerable to viruses, denial of service attacks, and many other insidious invasions.

To address these vulnerabilities, vulnerability scanning and resolution became a requirement for any organization with a computer network attached to a public network. Security consulting firms filled the market with a labor intensive approach to discovering and resolving network security vulnerabilities. More recently, some of the scanning functions have become automated, providing computer security personnel with the ability to find vulnerabilities in the local network. Tools were developed to help remediate the vulnerabilities

Large organizations created and connected to remote networks as their offices spread worldwide. These separate networks could be connected through internet communications in a configuration known as a distributed network. Yet, each network had its own security issues. Unlike the other functions of the businesses, there was no central control or management of the vulnerabilities.

Threats to the networks grew at an alarming pace, and each organizational network had its own peculiar needs and vulnerabilities. Organizations were forced to keep updated information on current threats and vulnerabilities. To ensure that the organizational networks were safe, organizations had to remain in contact with every vendor of their hardware and software, with governmental organizations that dealt with computer security issues, and with manufacturers of their hardware and software. Even in small networks, the task of maintaining relationships with dozens or hundreds of outside vendors was daunting, if not impossible.

U.S. patent application No. 2003/0126472 A1 to Banzhof describes a client server that connects to vendor websites. While this invention provides a means of electronically connecting to the vendors, the solution still forces organizations both to know which vendors they must contact and establish contacts with all of those vendors. In addition, Banzhof also assumes that the vendors have websites or other means of electronically disseminating vulnerability information.

A need still exists to provide a source for vulnerability information that is easily accessible and does not overburden organizations with a multitude of contacts.

### SUMMARY OF THE INVENTION

The present invention provides a system and method to overcome the problems in the prior art. A collocation facility can maintain or create communication links between vendors, suppliers, manufacturers, and other organizations, and can receive vulnerability information from these entities. The collocation facility also can receive information, from a plurality of customer organizations, describing their systems and software contained in their network. By correlating what is contained in the information with the appropriate vendor information, the collocation facility can send customized and specific information to each customer organization.

### BRIEF DESCRIPTION OF THE DRAWINGS

FIG. 1 shows an embodiment of a system to discover and remediate computer network vulnerabilities in a distributed network system according to the present invention.

FIG. 2 shows an embodiment of an Enterprise Server according to the present invention.

FIG. 3 shows an embodiment of a remote testing device according to the present invention.

FIG. 4 shows an embodiment of a collocation information system to distribute and receive vulnerability information among a plurality of Enterprise Servers according to the present invention.

FIG. 5 shows an embodiment of a method to disseminate vulnerability information from a collocation facility to a plurality of Enterprise Servers according to the present invention.

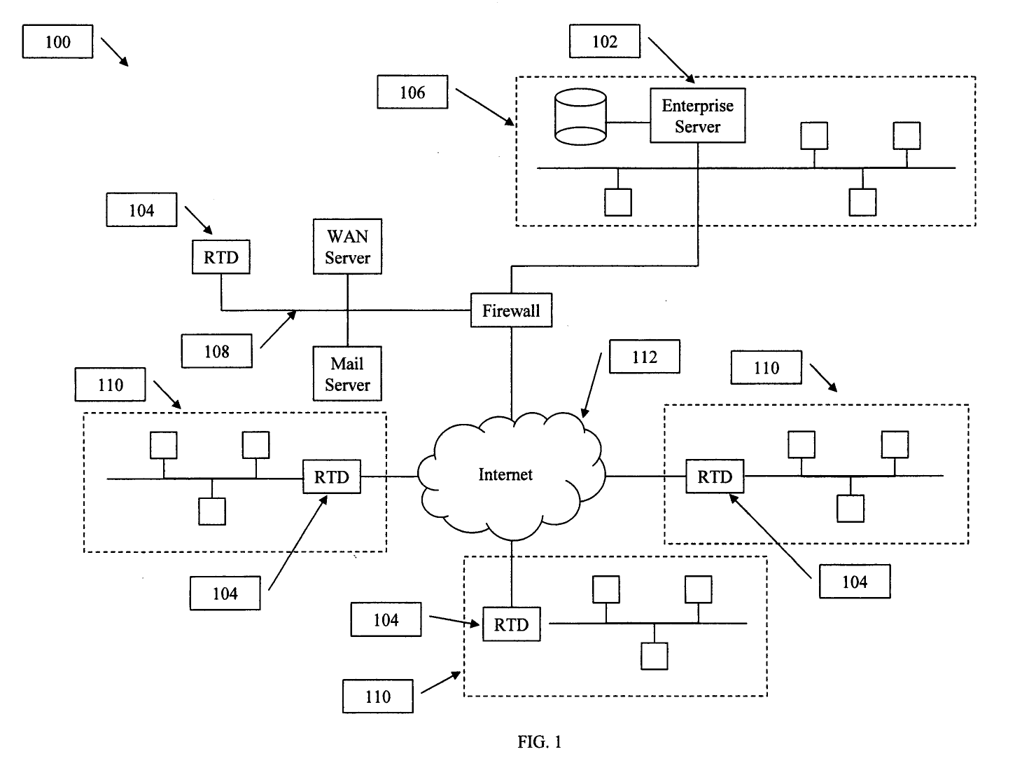

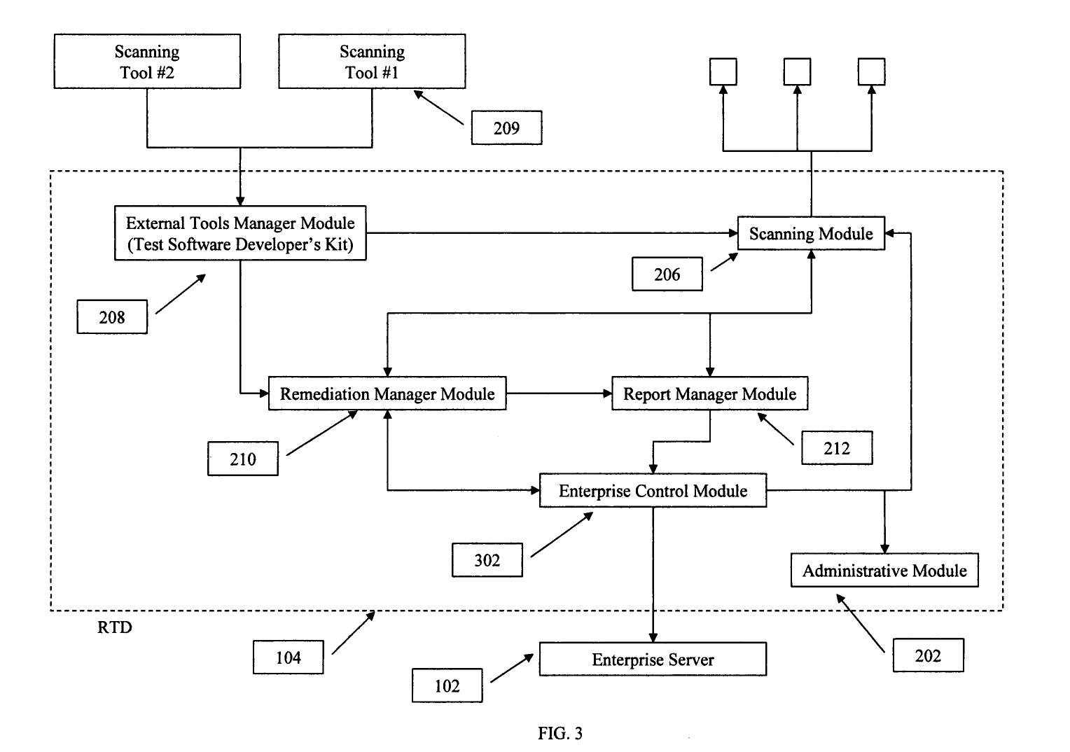

To clarify, each drawing includes reference numerals. These reference numerals follow a common nomenclature. The reference numerals will have three or four digits. The first one or two digits represent the drawing number where the reference numeral was first used. For example, a reference numeral first used in drawing one will have a number like 1XX while a number first used in drawing five will have a number like 5XX. The second two numbers represent a specific item within a drawing. One item in FIG. 1 will be 101 while another item will be 102. Like reference numerals used in later drawing represent the same item. For example, reference numeral 102 in FIG. 3 is the same item as shown in FIG. 1.

### DETAILED DESCRIPTION OF THE INVENTION

This disclosure sets forth specific embodiments and details to provide sufficient understanding of the present invention. However, one skilled in the art will recognize that the invention may be practiced without these specific details or in a form different than the specific embodiments. In addition, some diagrams use block diagrams or general schematics not to overburden the description with unneeded details. It will be noted that the invention may be performed in either hardware, software, or a combination of hardware and software. Certain terms and names are used to refer to particular systems throughout the description and the claims. One skilled in the art will appreciate that particular systems may be referred to by different names or different terms, and this description attempts to distinguish between components by function rather than name. Throughout this description, the term “couple” or “couples” means any type of direct or indirect electrical or communicative connection. Any network connections or transfers of information described hereinafter may be done in an XML format where possible.

Vulnerability Management System

The vulnerability management system 100 is a portal-like architecture as shown in FIG. 1. An Enterprise Server 102 is coupled to one or more remote testing devices (RTD) 104. The Enterprise Server 102 is a single unit located at a central location 106 or a headquarters location. Each RTD 104 is located on a sub-network 108 or a distant network 110 that is separated by some distance. Each distant network 110 or sub-network 108 may have one or more RTDs 104. The Enterprise Server 102 may communicate bi-directionally with the RTDs 104 through an internet 112, such as the World Wide Web, or through an Intranet, such as a LAN or WAN. Communications are completed in the network protocol of the internet or intranet used, but preferably, in an https protocol. This distributed vulnerability management model 100 provides remote scanning of several networks 108 or 110 and central control of the complete network vulnerability remediation system 100. Each of the systems will be explained in more detail below.

Enterprise Server 102

The Enterprise Server 102 functions as the central control for all of the RTDs 104. As an example, the Enterprise Server 102 can be a 1U rack mounted server operating a Linux operating system, coded in Java with an API program interface that can accept XML inputs. The server may be running a Pentium X86 processor and have a memory that can include a relational database developed in MySQL. The Enterprise Server 102 may also be a software module installed on a computer connected to the network. In addition, the Enterprise Server 102 may be a self-bootable program stored on a computer readable media that can be run from system memory of an existing network device. The Enterprise Server 102 may also be connected to one or more memories to store information in a database. The memories may include, but are not limited to, RAID systems, RAM, ROM, disk drives, optical storage, or tape storage.

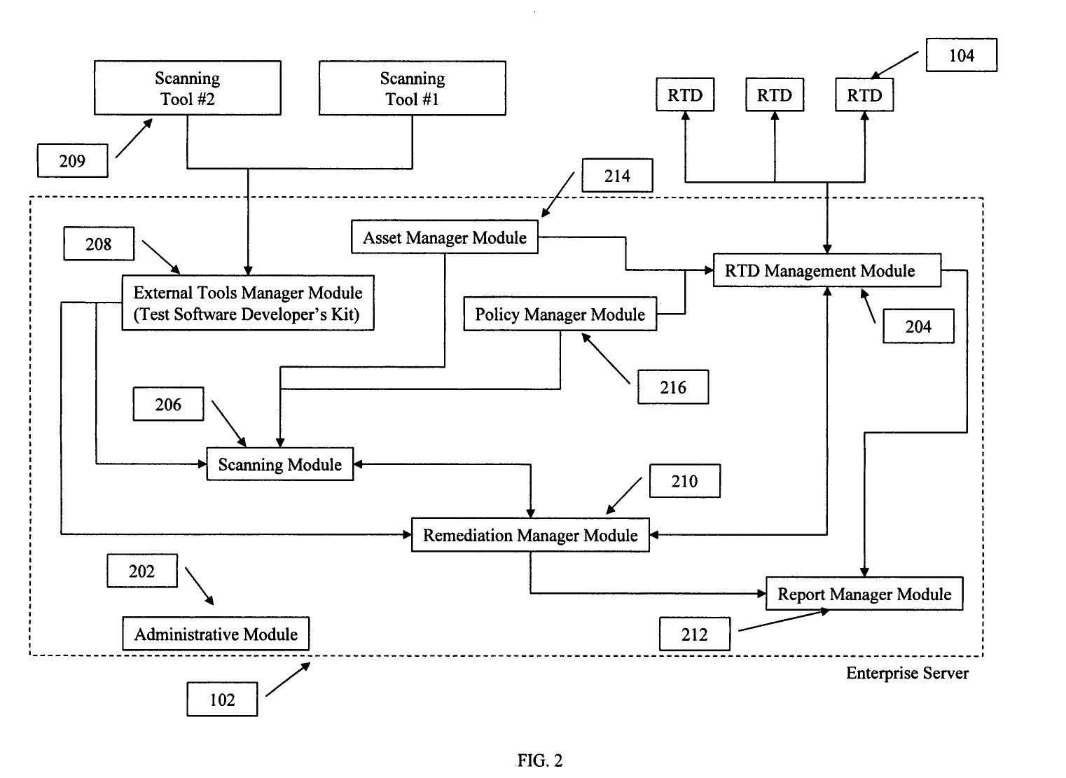

An embodiment of the Enterprise Server 102 is shown in FIG. 2. The Enterprise Server 102 includes a RTD Management Module 204. The Enterprise Server 102 may also include an asset manager module 214, a policy manager module 216, a scanning module 206, a remediation module 210, a report manager module 212, an administrative module 202, and an external tools manager module (also referred to as the software developer's kit or SDK) 208. Each of the modules has certain functions. One or more of the modules may be coupled or connected, sharing information either uni-directionally or bi-directionally. These modules may be integrated into a single computer or distributed among several computers. Each module with its functions and interconnections will be described further hereinafter.

The administrative module 202 controls access to the Enterprise Server 102. This module 202 assigns access privileges to different individuals. An identification code and a password may be given to each privileged user to allow them to access the Enterprise Server 102. Privileges may differ from person to person. Some people may have general access to the Enterprise Server 102, while other users may have more limited access.

The RTD Management Module 204 controls and interacts with the RTDs 104. The Enterprise Server 102 can determine for the RTDs 104 what tests and scans may be run, when the tests and scans may be run, on what system devices to run the tests and scans, and how to report and manage the vulnerabilities identified by the tests and scans. More specifically, the RTD management module 204 will connect with the each RTD 104 to establish a time to run a certain scan (or to run that scan immediately). For instance, one RTD 104 may be connected to a network in Europe. The RTD management module 204 can schedule that RTD 104 to run during the evening in Europe. A second RTD 104 may be in California, and the Enterprise Server 102 can schedule that RTD 104 to run the same scan during the evening in California. Thus, the RTDs 104 may run the same scans at different times in different places and be managed by the same RTD management module 204.

Once a scan is run by an RTD 104, the RTD 104 may report several items of information to the RTD management module 204 including, but not limited to, what systems are attached to the network at the remote location, what vulnerabilities exist, who uses the systems, what operating systems or software are run on the systems, or what are the characteristics of the systems. The RTD management module 204 may forward this information to other systems for further use. In return, the RTD management module 204 may send further information back to the RTD 104. For instance, the RTD management module 204 can send vulnerability updates to the RTD 104 for use in improved scanning, security policies to which the RTD 104 must scan for compliance, changes to the asset management policies at the remote location, assignments for resolving discovered vulnerabilities, or information on how to resolve discovered vulnerabilities.

The scanning module 206 scans for many different aspects that effect computer security. These scans can include, but are not limited to, scans to determine what devices are attached to the network, scans to determine what the attached devices are and what software they operate, and scans for open ports, unauthorized network services, viruses, or Trojan horses. Custom designed scanning software may be employed by the scanning module 206. However, the scanning module 206 may also employ one or more currently existing scanners including, but not limited to, ISS Internet Scanner, QualysGuard, NEssus, Eeye, Harris, Retina, Microsoft's hfNetCheck, or others. It is immaterial what types of scanners are used in the scanning module 206.

In still another embodiment, scanning tools 209 may exist outside the Enterprise Server 102. For instance, the network security personnel may already employ scanning tool #1 and tool #2 209. An external tool manager module or SDK 208 may provide an interface for these outside scanning tools 209. The SDK 208 can use, for example, an API interface to import XML output from the tools into the Enterprise Server 102. The SDK 208 can manipulate the data to conform to the internal protocols of the scanning module 206 and the remediation module 210.

A remediation manager module 210 helps the organization ameliorate the discovered vulnerabilities. The remediation manager 210 may organize the vulnerabilities into a vulnerability database. The database may include, but is not limited to, the vulnerability, a ranking of the vulnerability according to the possible damage it may produce or the likelihood of occurrence, a list of the devices affected and where the devices are located, a description of the vulnerability, who was assigned to resolve the vulnerability, and a method of resolving the vulnerability. The remediation manager 210 allows the vulnerabilities to be assigned to an IT administrator or computer security personnel for resolution of the vulnerability. The remediation database can track when the vulnerability was found, when it was resolved, and whether the resolution was verified. In some embodiments, information from the database may be included in the Client Master File (CMF) explained below. The remediation manager module 210 aids in all the informational requirements for resolution of the vulnerabilities.

The report manager module 212 provides detailed or summary information about the vulnerabilities and the remediation efforts. Some of the information the report manager module 212 may provide includes, but is not limited to, the number of vulnerabilities, the risk rating, where the vulnerabilities are, whether they have been assigned, to whom they have been assigned, whether the vulnerabilities have been fixed, when the fix was done, whether the fix was verified, and who fixed the vulnerability. The report manager 212 can provide either textual or graphical information about the vulnerability either to a display device or a printer.

The asset manager module 214 can create and store a file that documents the networks attached devices for both the local network and all distant networks. This file may be referred to as the Client Master File (CMF). The CMF may also include, but is not limited to, lists of operating systems, peripherals, software stored on devices, or other information. The CMF may be populated by the scanning module, by importing the information, or by hand entry. The asset manager module 214 may provide information to the scanning module 206 for what needs to be scanned.

A policy manager module 216 allows a system administrator or other personnel to create organization wide security policies. These securities polices may include, but are not limited to, allowable or disallowable programs, restrictions on certain computers or computer users, allowed systems or peripherals, and other security rules. The policy manager 216 can provide information to the scanning module 206 to narrow or broaden the focus of the tests run. In addition, the policy manager 216 may send the security policy to the RTD management module 204 for distribution to the remote RTDs 104. Thus, a consistent security policy can be adopted and disseminated throughout the organization.

Remote Testing Devices

The RTDs 104 provide the scanning function for the distributed networks. Thus, the present invention allows for local scanning but central control of the vulnerability remediation system. An embodiment of the RTD 104 is shown in FIG. 3. An RTD 104 monitors a network block or a range of IP addresses. The RTDs 104 may report the scanning results to the Enterprise Server 102 or receive updated vulnerability information from the Enterprise Server 102. The Enterprise Server 102 may function as a vulnerability scanner for the network to which it is attached.

In some embodiments, the RTD 104 is a hardware appliance connected to the network it monitors. In an exemplary embodiment, the RTD 104 is a 1U rack mount server running a Pentium Processor that operates a Linux operating system. An RTD 104 may also be software stored in memory on a computer connected to the monitored network. A unique embodiment employs the RTD 104 as a software function recorded on a computer readable media, such as a compact disc (CD). The CD may be a self-bootable program that does not reside in permanent storage but runs from memory, such as RAM or ROM, during its operation. After finishing the monitoring functions, the program is aborted, and the program is erased from the memory. Thus, the remote sites may not need to install any hardware or software but can use the CD to preform all the testing functions.

The RTD 104 includes a scanning module 206 and an enterprise control module 302. In addition, the RTD 104 may include an external tools manager module 208, a remediation manager module 210, a report manager module 212, and an administrative module 202. The scanning module 206, external tools manager module 208, remediation manager module 210, report manager module 212, and the administrative module 202 may function similarly to the similarly named modules in the Enterprise Server 102. The enterprise control module 302 receives the commands or requests from and sends information to the RTD management module 204. In turn, the enterprise control module 302 communicates with the other various modules to give effect to the Enterprise Server 102 commands or requests.

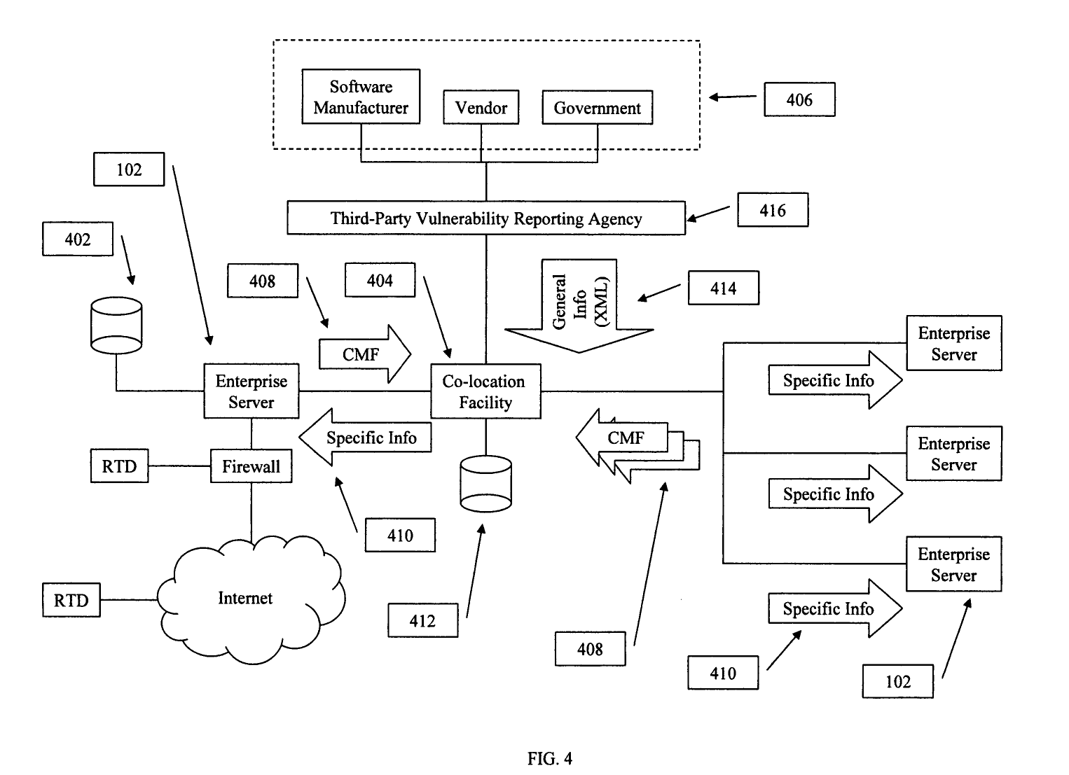

FIG. 4 shows a plurality of Enterprise Servers 102 that may manage the computer security vulnerabilities for a plurality of organizations. The organizations and their networks are wholly independent. The plurality of Enterprise Servers 102 is coupled to a collocation facility 404. The collocation facility 404 receives the CMF 408 from each Enterprise Server 102. In one embodiment, the CMF 408 may be used by the collocation facility 404 to specify the vulnerability information 414 required from the third-party vulnerability news organization 416. The third-party organization can then obtain information from the numerous contacts 406 (hereinafter referred to as simply vendors) including, but not limited to, particular vendors, manufactures, government organizations, or other entities. These updates 410 may be disseminated to the Enterprise Servers 102. Thus, the collocation facility 404 acts as a specific requester only obtaining information 414 that matches the needs of the organization according to the CMF 408. In another embodiment, the collocation facility 404 receives updates 414 from the third-party vulnerability news organization 416. These updates 414 may occur periodically or randomly. The vulnerability updates 414 may be in response to a request by the collocation facility 406 or a response to an emerging threat. In any of the embodiments, the collocation facility 404 may receive vulnerability information directly from the vendors 406 rather than a third-party 416. After receiving the vulnerability updates 414, the dissemination may be customized according to the contents of the CMF 408. In this embodiment, the collocation facility 406 acts as a central database 412 of all known vulnerabilities and only sends out the particular information requirements for each organization. Therefore, each Enterprise Server 102 receives updates specific to the hardware and software resident on that organization's networks. In addition, the Enterprise Servers 102 or organizations do not need to connect to the plethora of vendors 406 but only need to connect to a single source for all pertinent vulnerability information.

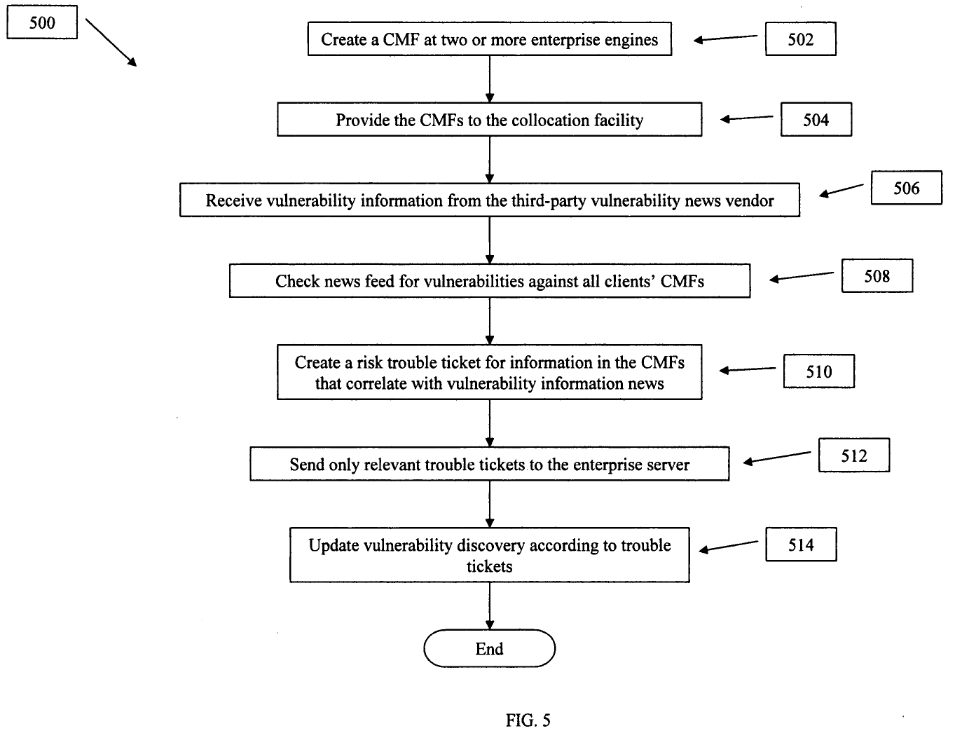

FIG. 5 shows an embodiment of a method for customized vulnerability alerting. Each Enterprise Server 102 creates 502 a CMF 408. Generally, the CMF 408 is created by the Enterprise Server 102 commanding a scan to be done on all networks. The RTDs 104 or the Enterprise Server 102 look for all attached computers and devices and records the type of computers and devices and their characteristics. Again, the CMF 408 file is a record of an organization's computers and network assets, but not necessarily any personably identifiable information. The file 408 includes, but is not limited to, a listing of all networks, sub-networks, remote networks, computers connected to the networks, peripherals or other devices connected to the networks, the operating systems used be the computers or devices, software used by the computers or devices, current vulnerabilities, recent changes to the computers or devices, or components of the computers or devices. The CMF 408 is stored in a database 402 at the Enterprise Server 102 or in a device coupled to the Enterprise Server 102.

Each Enterprise Server 102 sends 504 the CMF 408 to a collocation facility 404. The collocation facility 404 receives a plurality of CMFs 408 and stores these files in a database 412. There are several possible methods of retrieving the vulnerability information for each Enterprise Server 102. The vulnerability information in the CMFs and the trouble tickets, explained below, can be pushed or pulled. In other words, any information may be exchanged either through a request and response procedure or through an undirected transmission or retrieval of the material. Also, the information may be exchanged in XML format. One skilled in the art will understand how to create any type of system that can exchange information between the systems in the present invention.

In one embodiment, the collocation server 404 uses the information in the CMF 408 to determine which third-party news sources 416 must be contacted for one Enterprise Server 102. In other words, the collocation server 404 extracts which news sources 416 can supply the software or hardware information related to the organization according to the characteristics recorded in the CMF 408. These specific news sources 416 are contacted and requested to supply vulnerability information 414 specific to the systems documented in the CMF 408. Thus, news sources 416 that cannot supply information related to the organization are never contacted. In addition, news sources 416 that can information related to the organization need only reply with information 414 about the specific software or hardware listed in the CMF 408. The transmission of the on-going vulnerability information may also be specific to the CMF 408 stored at the collocation facility 404.

In another embodiment, the collocation facility 404 continually or periodically receives 506 vulnerability news updates 414 from the third-party news sources 416. Rather than request and receive specific updates, the collocation facility 404 receives all vulnerability information 414 released by the third-party news sources 416. This large amount of vulnerability information 414 can be stored in a database 412. The collocation facility 404 correlates 508 the information in the database containing all clients CMFs 408 with the vulnerability information 414 in the news update 402. Correlating the information 414 may include, but is not limited to, the aggregating similar information together so that the systems affected by certain vulnerabilities are easily identified and vulnerabilities are easy to find. Correlation may also include creating a modified CMF 408 file that will be sent to the Enterprise Server 102 to help define and narrow the scanning of the networks. Other data manipulation may occur that can be considered part of the correlation of the vulnerability information 414. The collocation facility can create 510 one or more trouble tickets, which includes the vulnerability warning matched to the CMF information, for vulnerability matching some information in any CMF. Relevant trouble tickets are sent 512 to the specific Enterprise Server 102 that may need the vulnerability information in the trouble ticket. Thus, the vulnerability information 410 is customized or particularized to the systems and networks in that organization. Each Enterprise Server 102 may then update the scanning tests to incorporate the new vulnerability information 410. Thus, each network makes customized and particular updates that are specific to their CMF 408 and the correlated vulnerability information 410. The Enterprise Server 102 uses the customized vulnerability information 410 to update 514 the discovery of vulnerabilities on that organization's networks.

We claim:

1. A computer security vulnerability remediation system, comprising:
a. a plurality of Enterprise Servers attached to a plurality of organizations' networks;
b. a plurality of vendors that supply vulnerability information;
c. a collocation facility coupled to the plurality of Enterprise Servers and coupled to the plurality of vendors; and
d. wherein the collocation facility receives vulnerability information from at least one vendor related to at least one organization's network, receives a Client Master File from at least one Enterprise Server, correlates the vulnerability information to the Client Master File, and sends the correlated vulnerability information to the Enterprise Server.

2. A method to provide customized vulnerability information to an organization, comprising:
a. collecting information at an Enterprise Servers to create a Client Master File;
b. sending the client master file to a collocation facility
c. receiving the client master file at the collocation facility;
d. obtaining vulnerability information from one or more vendors;
e. correlating the vulnerability information to information in the client master file; and
f. sending the correlated vulnerability information to the Enterprise Server.

3. A method to provide customized vulnerability information to two organizations with different vulnerabilities, comprising:
a. collecting information at a first Enterprise Server to create a first Client Master File of a first organization's network;
b. collecting information at a second Enterprise Server to create a second Client Master File of a second organization's network;
c. sending the first client master file to a collocation facility
d. sending the second client master file to the collocation facility;
e. receiving the first client master file at the collocation facility;
f. receiving the second client master file at the collocation facility;
g. obtaining vulnerability information from one or more vendors;
h. correlating the vulnerability information to information in the first client master file to create a first set of correlated vulnerability information;
i. correlating the vulnerability information to information in the second client master file to create a second set of correlated vulnerability information;
j. sending the first set of correlated vulnerability information to the first Enterprise Server; and
k. sending the second set of correlated vulnerability information to the second Enterprise Server.
